(19) United States
(12) Patent Application Publication
(10) Pub. No.: US 2001/0043467 A1
(43) Pub. Date: Nov. 22, 2001

(54) Luminary device with phosphorescent label

(76) Inventors: M. Scott Carpenter, Racine, WI (US); Kara L. Kotary, Racine, WI (US)

Correspondence Address: S.C. JOHNSON & SON, INC., 1525 HOWE STREET, RACINE, WI, 53403-2236, US

(21) Appl. No.: 09/753,842

(22) Filed: Jan. 3, 2001

Related U.S. Application Data
(63) Continuation-in-part of application No. 09/550,285, filed on Apr. 14, 2000.

(51) Int. Cl. F21V 9/16

(52) U.S. Cl. 362/84; 362/180; 362/182; 362/351

(57) ABSTRACT

A decorated luminary product includes either a candle or a candle holder containing the candle. A decorative web of a heat-shrinkable polymer web is heat shrunk to conform to a shape of either the candle or the candle holder. The web is decorated with a phosphorescent ink or pigmentation to cooperate with light emitted by the candle to provide a glow-in-the-dark effect when the candle is extinguished. Alternatively, the luminary product may be an oil lamp within a chimney or globe, and the phosphorescent ink or pigmentation may be charged by external ambient radiant energy to provide energy for emission in the absence of light.

### RELATED APPLICATION

This is a Continuation-In-Part application of Ser. No. 09/550,285, filed Apr. 14, 2000.

### FEDERALLY SPONSORED RESEARCH OR DEVELOPMENT

Not applicable.

### BACKGROUND OF THE INVENTION

1. Technical Field

The present invention, in general, relates to decorated luminary products, and more particularly relates to candle products decorated by the application of a decorative film having glow-in-the-dark or phosphorescent properties, either to the candles themselves, or to candle holders in which the candles are situated.

2. Background Information

Luminary products, such as candles and candle products come in many shapes, sizes, and designs. The terms “luminary, luminaries, and luminary products” shall be used herein in reference to combustible active material or fragrance delivery candles, or illumination devices which are wick based and burn a hydrocarbon-based fuel, such as candles or oil lamps or lanterns. For example, the invention is also applicable to illuminating devices in which the source of illumination is a burning wick, consuming lamp oil, and enclosed within a conventional oil lamp having a glass chimney. Some candles are intended to stand alone, while others are intended to be held upright as candlesticks, or in lanterns, jars, and the like. Other candles are intended to be situated in candle holders, and in the case of so-called gel candles and some wax candles, commonly called jar candles, the candles may substantially fill the volume of the holders in which the candles are situated.

More-over, it is to be understood that when a luminary, or a candle or candle holder is referred to, it is intended to include other forms of luminary devices as well, such as oil lanterns and lamps and globes for such.

In many of these cases, it is desirable to decorate the luminary products to improve their aesthetics, for both when the luminary is displayed unlit, and for when lit. However, it can be difficult and costly to decorate the exterior surface of a luminary or its holder. Also, many known techniques do not provide flexibility in production to easily change the particular decorative design. This limits the ability to provide cost-effectively a variety of designs, or to tailor the designs to the desires of the consumer, or to a specific season, event, motif, holiday or the like, or to provide a product having a decorative effect which changes in accordance with its surroundings, the light shining upon it, or through it, and whether the luminary is itself lit or unlit.

Therefore, there is a need in the art for a cost-effective decorating method which permits greater flexibility in production to allow a change from among varied decorative designs, and provides a decorative luminary product.

It has long been known to encase candles in protective material. For example, U.S. Pat. No. 2,137,707, of Wade, et al., relates to a process for packaging tapered candles in a seamless casing formed of a non-fibrous, cellulosic material. The casing may be transparent, translucent and/or colored. In one embodiment, the non-fibrous, cellulosic material is formed into a tube, which is wetted to soften the material for application to the candle. The diameter of the wet tube is substantially equal to the mean diameter of the tapered candle, and as the wet tube is pushed down onto the candle, or a mandrel having the same dimensions as the candle, it stretches as necessary to fit over the wider end of the candle. Then, the covered candle is dried, and the tube forms a protective casing that conforms closely to the shape of the candle, and will retain the candle wax whether in a solid or melted state.

It has also been known to wrap candles in heat-shrinkable films for shipping and display. In U.S. Pat. No. 3,126,682, Krance teaches a method of wrapping candles. A tube of heat-shrinkable film material is loosely formed about the candle by shaping a web of the material about the candle with overlapping longitudinal edges. By grasping the tube just beyond each end of the candle, the wrapped candle is carried past a heat source, by which the material is heat shrunk around the candle. The material selected has two important characteristics: it will not shrink any further once it contacts the surface of the candle, and it holds a high charge of static electricity which causes it to cling when overlapped. Thus, the material is not heat sealed, but rather is held together statically around the candle after shrinking to a tight fit..

It has also been known to apply heat-shrinkable wraps on various objects for decorative purposes. For example, U.S. Pat. No. 3,829,348, of Spiegel et al., relates to decorating three-dimensional objects such as ornaments, glassware, or electric bulbs. The object is decorated by heat-shrinking a decorated tube or band of heat-shrinkable plastic about the object. The tube or band is decorated by applying precut patterns, silk screening, striping or the like, prior to application of the tube or band to the object to be decorated. The plastic is preferably polyvinyl chloride (PVC) or polyethylene, which is uniaxially oriented, resulting in a 30-50% diametric shrinkage versus only a 2-10% height shrinkage of the tube, resulting in an intimate contact of the entire interior surface of the band or tube with the exterior surface of the decorated object.

Similarly, US Reissue Pat. RE. 20,434, of Barrett, Jr., teaches the preparation of a sanctuary candle, wherein the body of the candle is tightly jacketed in a cylindrical transparent film of amorphous cellulose, fitted to the candle while still un-dried. It is taught that the film may be either clear or colored, and may be combined with a colored glass tube forming the outside of the assembly, which includes a bottom assembly and a cap.

In co-pending patent application Ser. No. 09/550,285, filed Apr. 14, 2000, Kotary et al. disclose a technique for the application of a shrink-wrap decorative film to a candle for the purpose of providing a cost-effective and flexible method for providing a variety of decorative effects upon candle products. That co-pending application is directed specifically to methods of application of shrink-wrap films to a candle product, and the products obtained by such methods, with little discussion of the visual effects attainable therewith.

The present invention relates to luminary products which are luminescent in nature, in that they emit or radiate light by means other than heat per se. As used herein, the term “luminescence” shall refer to the radiation of light from a body by means other than heat; luminescence being generally understood to be available from either phosphorescence or fluorescence. It is to be understood that as used in the present application, the term “phosphorescence” shall be understood to mean the emission of light following exposure to and removal of incident radiation, or the emission of light without burning. Conversely, “fluorescence” shall be understood to mean an effect in which a substance releases radiation while absorbing another energy form, but ceases to emit radiation immediately upon the cessation of the input energy. An example of fluorescence would be the absorption of ultraviolet light by the coating in a fluorescent light tube to give off light in the visible spectrum. Accordingly, and in summary, the present invention is directed to luminescent coatings applied to shrink-wrap materials applied to a candle or candle holder, which coatings emit light after being “activated” or “charged” by the burning of the luminary product or by an external light source.

As previously stated, the use of fluorescent and phosphorescent materials for various purposes is known. For example, U.S. Pat. No. 5,172,937, of Sachetti, discloses divers structures, including covers, label, toys, and figurines, containing fluorescent and phosphorescent materials which emit and reflect light to provide a sense of identity, security, comfort, and amusement. When a label including such materials is subjected to light such as sun light or incandescent lighting, the phosphorescent material in the label is activated, and will release light in the darkness.

Similarly, U.S. Pat. No. 5,654,552, of Toombs, teaches a lamp shade including a glow-in-the-dark region printed thereupon. Toombs suggests the use of glow-in-the-dark ink to form a pattern on a cloth layer which is bonded to a transparent plastic layer of a lamp shade, to provide a visible pattern both when the lamp is illuminated and when the illumination ceases.

In addition to the above, Sylvestre teaches, in U.S. Pat. No. 5,154,600, an emergency kit including a candle with illumination bands which enable one to locate and utilize the candle under low light conditions. While a convenient means to assist in the location of a candle at a time of electrical power failure, the candle of the kit does not constitute a decorative candle which bears an illumination band or indicia which may be activated by the light of the candle to emit light after the candle is extinguished.

Bryant, in U.S. Pat. No. 3,741,711, teaches a composite indefinitely reusable decorative candle comprising a central insulated recess into which a glass cup is positioned, containing a burnable candle, such as a votive candle. The glass cup and the candle therein may be replaced indefinitely. The main body of the candle is made of a clear wax, and a clear colorless insulating material surrounds the clear glass cup to prevent the main body of wax from being melted by the burning of the small candle. The outer body of the candle may be decorated with a design or ornamental configuration, which are caused to appear to be luminescent when the candle is burned. The reference, however, does not suggest the use of fluorescent or phosphorescent materials, but merely takes advantage of the glow of the burning inner candle to cause the outer candle to appear luminescent.

In addition to the above, there are any number of references which teach the application of decorative and/or identifying materials, such as labels, to the exterior surfaces of various items. For Example, Bright et al., in U.S. Pat. No. 5,879,496, teach a method for labeling convex surfaces, such as bottles, eggs, Christmas tree ornaments, and the like, by attachment of both ends of a segment of heat shrinkable material to the surface with an adhesive, followed by heat shrinking the major portion of the segment to a tight adherence to the surface. Conventional heat-shrink materials are employed, having a high degree of orientation of shrinkage. Heat shrinkable polyester films having particularly favorable shrink characteristics are taught by Mori et al, U.S. Pat. No. 5,932,685. The shrink-wrap films of this reference are said to be preferable due to the fact that not only do they undergo relatively little longitudinal sinking when shrunk, but that they also have very few wrinkles, shrinkage spots, or strains remaining after shrinkage.

Thus, there are a number of teachings of films suitable for shrink wrap application to an object for decorative purposes, but none which teach the shrink wrap application of a glow-in-the-dark label bearing a design, print, or indicia which are responsive to light from a candle or similar flame, in that they are “charged” by the light of the candle or flame during burning, and emit light, or glow in the dark after the candle or flame is extinguished.

Such inks are well known, and have been applied to various surfaces for many years, for decorative and for safety-illumination purposes. However, none have been suggested as suitable for shrink-wrap application to a substrate to be lit by a candle for subsequent luminescence. Further, high transparency of the shrink wrap label is desirable, to allow background lighting to show through, such as when applied to the outer surface of a candle holder, so that light from the burning candle will show through the film, while the printed area of the film simultaneously absorbs light from the candle, and subsequently emits light after the candle is extinguished, to provide a striking visual effect. None of the previously discussed references provide such an effect.

Thus, it has not previously been proposed to decorate a luminary product such as a candle or a candle holder with a heat-shrinkable film having properties such that the film emits light after the candle is extinguished. The product thus is visually pleasing not only during burning, but when displayed unlit. It is to be noted that the glow-in-the-dark materials used in the present invention may be “charged” not only by the candle light when the candle is lit, but by ambient light when the candle is unlit but in a well lit environment. Thus, the decorative candle of this invention will glow in the dark after sitting unlit on a table in a well lit room, after the lights are extinguished. Further, it has not been suggested to decorate a candle or holder, which will be subject to elevated temperatures during normal use, by application of a heat-shrinkable film having such properties as phosphorescence or luminescence. The known art does not suggest such an application, nor does it suggest with any certainty that heat-shrinkable polymers could be used to decorate such a combustible product with the desired result.

### SUMMARY OF THE INVENTION

The present invention addresses the foregoing by providing a product and method in which a luminary product is decorated by enveloping the luminary, candle, or holder, in a decorative, heat-shrinkable polymer wrap having the specified properties, and heat-shrinking the wrap about the luminary, candle, or candle holder.

The novel luminaries obtained by the practice of this invention produce visual effects which are inexpensive, visually pleasing, capable of being readily found in a darkened room, and capable of being provided with a large variety of designs, such as with seasonal or holiday themes.

In one aspect, the present invention relates to a method of decorating a candle product, and includes the steps of providing a web of a heat-shrinkable polymer having a specific decorative feature, and encasing with the web a luminary product. After the encasing step, the web is heated to shrink the web to conform to a shape of the luminary product. In a case in which the luminary product comprises a candle holder, a candle may be inserted into the candle holder to enhance and enable the effect of the polymeric wrap employed. Thus, in one aspect, the present invention relates to a decorated candle product including a candle and a candle holder containing the candle. A decorative web of a heat-shrinkable polymer web having a luminescent pattern printed thereupon is heat shrunk to conform to the shape of the candle or the candle holder. The web has a decorative feature, i.e. a pattern printed in a luminescent, phosphorescent, or fluorescent ink, which feature cooperates with light emitted by the candle to enable the visual effect created when the candle is extinguished. While the following description is written primarily in terms of application of a web to a candle holder, the present invention is also applicable to the application of a web to a candle per se. As an example, pillar candles may be wrapped with a web having a decorative feature, particularly where the diameter of the pillar candle is sufficient that the walls of the pillar candle remain thick enough to prevent softening or melting of the outer surface of the candle as the flame consumes the central portion of the candle. Another example of a candle having a wrap applied in accordance with the present invention would be a pillar candle having a centrally located candle holder in the “bore” of the candle, said holder being suitable for containing and burning a small candle, such as a votive candle or tea light. In such instances, the flame at the wick of the candle will illuminate the outer surface of the candle from within, and excite the glow-in-the-dark ink on the decorative wrap, which will then emit light after the burning candle is extinguished.

These and other aspects, objects, features, and advantages will be more evident from the following description and drawings, in which like reference numerals relate to like elements throughout.

### BRIEF DESCRIPTION OF THE DRAWINGS

FIG. 1A is a perspective view of a decorated luminary product according to one embodiment of the present invention.

FIG. 1B is a perspective view of a decorated luminary product according to another embodiment of the present invention.

FIG. 2A is a flow chart illustrating a product decorating method according to one embodiment of the present invention.

FIG. 2B is a flow chart illustrating a product decorating method according to another embodiment of the present invention.

FIG. 3 is a perspective view illustrating a step in the product decorating method according to one embodiment of the present invention.

FIG. 4 is a perspective view illustrating a step in the product decorating method according to another embodiment of the present invention.

FIG. 5 is a flow chart illustrating in more detail a preferred embodiment of a step in a product decorating method according to one embodiment of the present invention.

### DETAILED DESCRIPTION OF THE PREFERRED EMBODIMENTS

Various embodiments of a decorated luminary product may formed in accordance with the present invention. In each embodiment, the luminary product is decorated by enveloping an exterior surface in a decorative, heat-shrinkable polymer wrap and heat-shrinking the wrap about the surface to cause it to adhere tightly thereto. While it is possible to cause the decorative wrap of the invention to adhere to the candle product by other means, the preferred means comprise heat shrinking a heat shrinkable film to an adherent condition upon a surface. However, as will be evident to one skilled in the art, the decorative films used in the present decorated luminary device may be applied by such alternative means as attachment with holding devices such as staples, pins, tape, etc., particularly when being attached to candles per se.

As previously indicated, the basic concept of the present invention is the provision of a decorative glow-in-the-dark surface upon a luminary product. The luminary product may comprise a candle, a lamp, or a holder or container for a candle or lamp. For example, the present invention is inclusive of candles having a decorative film on the outer surface thereof, a candle holder having a decorative film on either the inner or outer surface thereof, or a lamp chimney or globe having a decorative film on either the inner or outer surface thereof. As examples of the invention, Applicants believe that decorative candles, in the form of candle sticks, jar candles, or votive candles which either bear a decorative film upon the surface thereof, or are placed within a container, such as a glass jar decorated as taught hereinafter, fall within the scope of the present invention, as well as various configurations of globes or lantern chimneys, usually made of glass, designed to surround, enclose, encompass, retain, or hold candles of various shapes, oil burning lamps, or various wicks which burn carbon-based fuel, which globes or lantern chimneys bear upon their surfaces a decorative film in accordance with the teachings of this disclosure. While the use of transparent globes, chimneys, or candle containers (such as jars) is preferred, it I s possible to utilize opaque or translucent materials as well, although the visual effect is not as pronounced in such a case.

The present invention is particularly applicable to candles, candle holders, oil lamps, and the like which dispense an active material. Such active materials are well known in the prior art, and may be selected from the group consisting of fragrances, air fresheners, deodorizers, odor eliminators, malodor counteractants, insecticides, insect repellants, medicinal substances, disinfectants, sanitizers, mood enhancers, aroma therapy compositions, and mixtures thereof. The choice of specific active materials present in the luminaries of the present invention, if any, are within the skill of a practitioner of the art to which the present invention applies. However, preferred active materials which may be included in the wax of a candle, or in the oil of an oil burning lamp, include fragrances, insect repellants, insecticides, and deodorizers. Such active materials may be added, in liquid or gel form, to the fuel element of a candle or lamp to be dispersed to the atmosphere upon burning of the fuel. The present invention is of particular value in the preparation of luminaries including a candle comprising a mood enhancing or aroma therapy additive, said candle being surrounded by a globe, chimney, or container decorated with a glow-in-the-dark pattern.

Thus, the invention broadly encompasses a luminary product having a decorative glow-in-the-dark label or film associated with it, in a position such that the glow-in-the-dark ink may be illuminated by the flame of the luminary product when lit, and emit light to the viewer when the flame is extinguished. The glow-in-the-dark ink may also absorb radiant energy from ambient lighting when the flame is unlit. The glow-in-the-dark feature is provided by means of a heat shrink film bearing said ink, said film being adhered to the outer surface of the luminary product in such a manner as to be illuminated by the flame thereof, or alternatively, by ambient light when the luminary flame is unlit. The glow-in-the-dark label emits light after the burning element is extinguished, and when the ambient light level is below the level of light emission of the ink employed. It is to be understood that the radiant energy necessary to excite or charge the phosphorescent material utilized in the present invention includes not only ambient light including light from external sources such as electric lighting in a home, or sunlight , but also includes the light released by a flame burning at the wick of a candle, or on the wick of an oil lamp, or other such sources of radiant energy. Thus, ambient light is to be understood to encompass not only light from external sources, but the light of the candle or luminary product of the invention, while lit. The labels employed are applied by heat shrink techniques to substrates such as candles, candle jars, globes, votive jars, and chimneys, to provide a highly decorative luminary product. The preferred methods for the application of such films to a luminary product are set forth in copending U.S. patent application Ser. No. 09/550,285, filed Apr. 14, 2000, incorporated herein by reference.

The glow-in-the-dark-in-the-dark inks may be any suitable inks for imprinting upon a shrink-wrap label of the type employed in said copending U.S. patent application Ser. No. 09/550, 285. Exemplary of such inks are those prepared from Luminous Glow Powder sold under the tradename HY-Series Luminous Material, available from Pete's Luminous Creations, of Singapore. Such photo storage materials are based upon a non-radioactive crystal which is available in green, blue, yellow, and violet, in particle size of 200 to 500 mesh, The 200 mesh size is suitable for most applications except silk screen printing, or offset printing, where a finer particle size of 400 to 500 mesh is recommended. The crystals of this composition decompose in water, and accordingly must be applied as non-aqueous dispersions, such as solvent based inks. The Glow Powder may be mixed with suitable clear inks to form Luminous Inks. The mixing ratio of powder and ink is approximately 1:1, but generally speaking, the luminescence is greater with higher proportions of luminous material is present, and when more than one coating of ink is applied. Application to a clear or white film is preferred, since a dark background tends to absorb light, and reduce luminescence. The Glow-in-the-dark Powder may also be utilized to form an epoxy coating by combination with Epoxy, Hardener, and powder. Other glow-in-the-dark materials are also available commercially, such as phosphorescent pigments sold by Thermal Lettering, of Loveland, Co. Application of the phosphorescent pigment or ink to a shrink-wrap material may be done by any appropriate means, including painting, application by rubbing or contacting the surface with the pigment or ink, or by printing, such as by flexography, gravure, or screen printing, with screen printing being preferred.

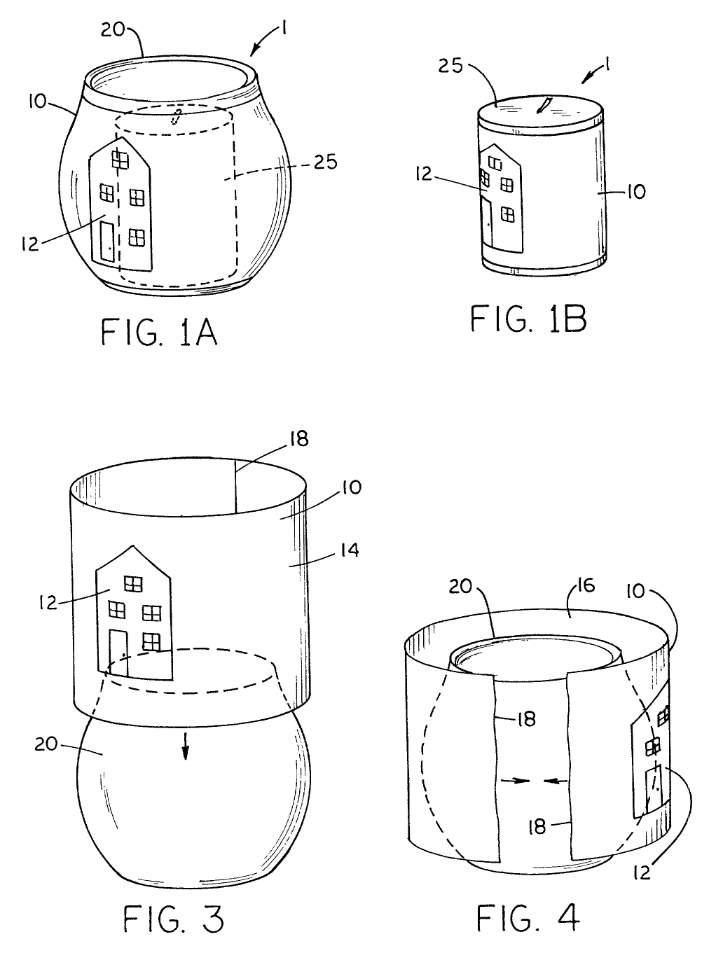

FIGS. 1A and 1B illustrate two embodiments of a decorated luminary product 1 formed in accordance with the present invention. In each embodiment, the luminary product 1 is decorated by enveloping the exterior surface 1 in a decorative, heat-shrinkable polymer wrap 10 and heat-shrinking the wrap 10 about the candle product 1. As shown in FIG. 1A, the wrap 10 can be heat shrunk to a candle holder 20 in which a candle 25 is carried. Alternatively, as shown in FIG. 1B, the wrap 10 can be heat shrunk directly to the candle 25. The candle and candle jar shown in FIGS. 1A, 3, and 4, are, for purpose of illustration with no limitation, jar candles such those sold under the trademark Glade® Candles, commercially available from S. C. Johnson & Son, Inc., of Racine, Wis.

The wrap 10 is a polymeric material having properties such as to provide the desired glow-in-the-dark properties of the present invention. That is, the wrap constitutes a film upon which is deposited a glow-in-the-dark ink, either in a random manner, or in a desired pattern, which ink will be “charged” or radiantly excited by the incidence of light, and which will emit or radiate light after the incident light is extinguished. As indicated, the glow-in-the-dark ink may take a pattern, such as a drawing, an image, a print indicia, or the like, or may be a totally random “splash” of coloration, either in a single color, or in a combination of colors.

For example, the wrap 10 may be provided with a design 12 that should not only improve the appearance of the candle 25 or holder 20, but should cooperate with light emitted by the candle 25 (i.e., be illuminated by the light of the candle flame) to augment the visual effect created when the candle 25 is burning. For example, the base wrap 10 may be colored and translucent. This will augment any surface features (e.g., fillets, flutes or the like) of a candle holder 25 in a similar manner as would tinted glass. Alternatively, the wrap 10 may be selectively transparent, translucent and/or opaque to provide a desired light pattern when the candle 25 is lit. The design 12 can be provided by any of a number of suitable processes, such as printing (including using phosphorescent, Day-Glo7, glow-in-the-dark, luminescent, or other inks) or finishing (including providing gloss, matte, or other specialty finishes). As previously indicated, a preferred embodiment of the invention comprises a glow-in-the-dark label having a clear film background with a colored design or indicia imprinted thereupon, applied to a transparent glass candle holder, in such a manner that the design or indicia is backlit by the flame of the candle during burning, and absorbs radiant energy from said flame while it bums. Upon extinction of the flame, the glow-in-the-dark printed design or indicia emits radiation or light into the darkened environment, showing the design or indicia in the dark, while other portions of the label, not printed in phosphorescent inks, are not shown. By printing the label with a plurality of colored phosphorescent inks, either in single pass printing processes, or in multiple applications of different inks, complex multi-colored designs may be obtained, which will absorb light from the candle while the candle burns, as well as from any other ambient light, and emit radiant energy in the form of a glow-in-the-dark pattern of multiple colors, for a period of time after extinction of the candle. If the candle is in a darkened environment at the time of extinction of the candle, the pattern of the design will be quite noticeable and pleasing to the eye. For example, a candle wrap of the present invention may be printed in conventional manner with a design of a flower, with the leaves printed in phosphorescent inks which emit radiation in the green wavelengths, while a flower bud and petals may be printed in an ink which releases light in the red wavelengths. After extinction of the candle and any additional ambient light, the image of a flower is seen in the dark.

In the embodiment illustrated in FIG. 1A, in which the wrap 10 is applied to the holder 20, the candle 25 disposed in the holder 20 can be formed of wax, gel or other suitable candle-forming material. Additionally, the candle 20 could be any combustible fragrance delivery or illumination device that is wick based and burns a hydrocarbon-based fuel, so that an active material may be released to the atmosphere during burning of the candle, and a glow-in-the-dark image will show upon extinction of the candle.

There were initial concerns about whether heat-shrinkable polymers could be used to decorate such a combustible product. However, we have found that the preferred wrap materials, poly(ethylene terephthalate) (PET), and polyester glycol (PETG) withstand the expected conditions (e.g., extended exposure to temperatures of up to about 150° F.) of use, and perform acceptably when exposed to such non-standard conditions as flare-ups (during which temperatures can approach about 600 to 800° F.), misaligned wraps, and the like. Although such materials are preferred, the wrap material may be any of a number of suitable heat-shrinkable polymer films, including PVC, polyethylene, polystyrene, other polyesters, and the like, so long as the film is not adversely affected by the temperatures encountered during normal candle use. Further, if the wrap 10 is to be applied directly to the candle 25, we prefer that the wrap film be heat-shrinkable at sufficiently low temperatures or brief exposure times so that the candle 25 itself will experience little or no melting during the shrinking process. For the sake of convenience, the film application, or wrap, shall be described herein as application to a candle or to a candle holder, or simply a holder, it being understood that the terms “candle holder” and “holder” are intended to encompass all forms of globes, jars, chimneys, lamp exteriors, and enclosures suitable to surround a candle or lamp flame, through which the light of said flame would normally be observable.

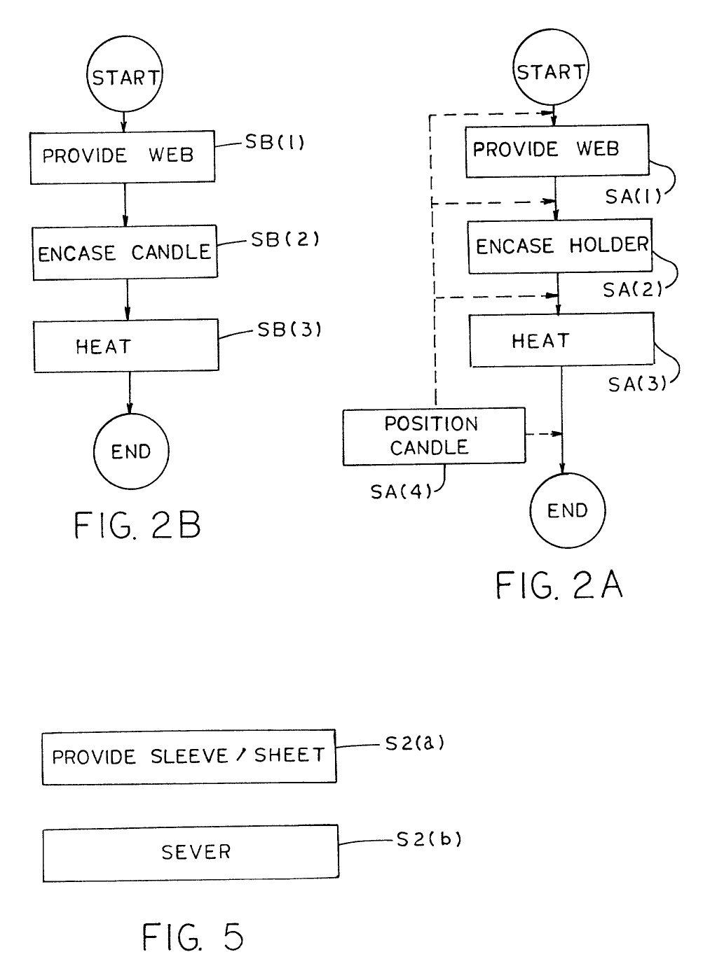

Referring to FIGS. 2A and 2B, the decorating processes for the wrapped-holder and directly-wrapped-candle embodiments, respectively, each includes the step of providing a web of wrap film [steps SA(1) and SB(1)]. Preferably, but not necessarily, the wrap film will be provided in individual pieces: preformed, closed loops or bands 14 that fit over a candle 25 or holder 20 (as shown in FIG. 3) or panels 16 that are wrapped about a candle 25 or holder 20 (as shown in FIG. 4). In each of these cases, as shown in FIG. 5, the step of providing the web [step SA(1) or SB(1)] can include the steps of providing a continuous sleeve or sheet [step S2(a)] and severing the sleeve or sheet into the individual pieces [step S2(b)]. Alternatively, the web can be cut into pieces later in the process, such as after the web encases the candle product 1 (as discussed hereinafter).

In any case, the edges 18 of the film are overlapped and seamed in a known manner, either before (in the case of bands 14) or after (in the case of panels 16) application to the candle holder 20 or candle 25. For example, the edges 18 may be solvent sealed, heat sealed, adhesively sealed, sonically welded, or the like. In the case of bands 14, the edges are joined at sleeve formation, which in a preferred embodiment is done by joining opposing transverse edges of a “continuous” web of the film by tetrahydrofuran (THF) solvent applied in a known manner. Also, the design 12 preferably will be applied to the film before it is severed into individual pieces. In the case of bands 14 (as shown in FIG. 3), the design 12 is preferably applied to the continuous web in advance of the sleeve formation, by printing, or by similar appropriate application means, using phosphorescent inks. It is also possible for the design to comprise both non-phosphorescent and glow-in-the-dark design elements, so that differing designs show in the presence and absence of either candle light or other ambient lighting.

The film of the wrap 10 may be oriented so as to shrink predominantly in a single direction, thereby improving the predictability of the shrink-wrapping process. This can be accomplished in a known manner. For example, prior to formation of the individual pieces, while the film still comprises a generally “continuous” web, the film can be heated and stretched in one direction. Usually this will be done in the cross-machine direction (transverse to the length of the continuous web). When the film is heated again later, in a heat-shrinking process, the film will shrink predominantly in the direction in which it has been stretched. Although not necessary to the invention, it would be preferable to orient the film so as to shrink about the candle product 1 to a much greater extent in the circumferential rather than axial direction. This facilitates orientation of the film relative to the candle 25 or holder 20. The not-yet-shrunk film can be placed loosely about the candle 25 or holder 20, and the top or bottom edge of the film can be aligned substantially with its intended final position. As the film shrinks (predominantly circumferentially), the film will close tightly about the candle 25 or holder 20 without undue axial displacement of the top and bottom edges of the film.

The preferred PET film is about 25 to about 60 microns thick and is oriented transversely so as to exhibit the following shrinkage characteristics when submersed in heated water for fifteen minutes:

| Water | Shrinkage (%) | |
|---|---|---|
| Temperature (? C.) | Machine direction | Cross-machine direction |
| 80 | <4 | 50-60 |
| 100 | <3 | >70 |

The individual bands 14 or panels 16 for application to each candle 25 or holder 20 can be produced by severing the continuous sleeve or sheet [step S2(b)] at a timing metered by the output of a photosensor. The photosensor can be employed to detect predetermined registration markers on the sleeve or web, in order to ensure that the sleeve or web is severed at appropriate intervals given the design 12 on the film. (If desired, the photosensor detection “window” can be limited to specified time periods in a known manner.) If the decorative design 12 is a repeating pattern, then the photosensor can key on a specific aspect of the pattern. If the design is not repeating or repeats less frequently than every cutting interval, then a standard registration marker can be provided. For example, a clear box with a specified border can be incorporated into each design 12 at the same location in the individual band 14 or panel 16. This permits a single web to bear more than one design 12, resulting in bands 14 or panels 16 that differ from one another in design. This greatly increases the ease and cost-effectiveness of producing candle products 1 decorated with varied designs, particularly bearing a plurality of glow-in-the-dark inks.

Returning to FIGS. 2A and 2B, in step SA(2) and SB(2), the holder 20 or candle 25 is encased by the heat-shrinkable wrap. (See FIGS. 3 and 4.) In the preferred embodiment, this is done with a band 14 or wrapped panel 16 that is slightly larger in circumference than the target candle 25 or holder 20. In the case of, for example, a candle holder 20 that is not cylindrical (i.e., it is wider in some places than others), the band 14 or wrapped panel 16 should be slightly larger in circumference than the widest part of the candle holder 20. This, however, is not necessary; the band 14 or panel 16 can be stretched onto a larger candle holder 20 if desired.

The height of the band 14 or panel 16 can be very close to the desired height of the finished design on the candle 25 or holder 20. As noted, an oriented film can be used in known manner to provide a band 14 that shrinks predominately in the circumferential direction, with very limited shrinkage in the axial direction.

A typical band 14 will be described for application to a curved holder 20 that is approximately 68.6 mm tall and has a side wall that is approximately 70.6 mm in diameter at its mouth, bulges to approximately 80.8 mm in diameter (approximately 253.8 mm in circumference) at its widest point, and tapers to approximately 40.5 mm in diameter at its base. The elongated sleeve, from which the bands 14 are formed, is approximately 260.75 mm in circumference (corresponding to approximately 83.0 mm in diameter). The sleeve is severed transversely into bands 14 that are approximately 71.0 mm in height. Thus, each band 14 is approximately 7.0 mm larger in circumference than the holder 20. Each band 14 is also approximately 2.4 mm taller than the holder 20. However, due to the rounded side wall of the holder 20, the actual distance along the side wall from top-to-bottom actually exceeds the height of the band 14 by a few millimeters.

The thus-formed band 14 is then placed over the candle holder 20 (see FIG. 3). At this stage of the process for wrapping a candle holder 20 (illustrated in FIG. 2A), it is preferred that no candle 25 be present, although this is not necessary to the invention. This permits the holder 20 to be oriented upside-down on a carrying surface (such as a conveyor belt or tray) for band application. This provides several advantages. In this orientation, the band 14 can rest against the carrying surface at the outset of heat-shrinking. This prevents the wrap 10 from overlapping the mouth of the holder 20. It also provides a reference surface to keep wrap 10 from skewing relative to the holder 20. A secondary advantage is that the absence of the candle 25 at this stage avoids subjecting candle 25 to the elevated temperatures of the heat-shrinking process, which could result in some softening or melting (although the melting can be kept to a minimum, as in the case of the application of the wrap 10 directly to a candle 25).

It should be noted that the candle 25 may be positioned in the holder 20 [step SA(4) in FIG. 2A] earlier in the process, and may be present before the wrap 10 is applied to the holder 20. For example, in the case of gel-candles or pour-in wax candles, the candle may be poured into the holder 20 at any point in the process, as shown by the dashed lines in FIG. 2A. In fact, it is possible that the candle may be at such a temperature when poured into the holder, that the candle itself can contribute to or achieve the heating step (discussed below).

In the case of application of a wrap 10 directly to a candle 25 (FIG. 2B), it is preferred to orient the candle 25 upright. This makes it easier to orient the wrap 10 so that it does not interfere with the wick. This also minimizes the effect on the wick of whatever small degree of melting that might occur during heat-shrinking.

Once the band 14 or panel 16 is positioned about the candle 25 or holder 20, the combination can be fed by any known mechanism (e.g., a conveyor belt) into a heating station, where the band 14 or panel 16 is heat shrunk onto the candle 25 or holder 20 [steps SA(3) and SB(3)]. The heating station can apply hot, dry air; hot, humid air or steam; or some sequential combination of hot air and steam. The sequential combination is preferred in order to best avoid wrinkles and bubbles in the finished wrap 10, in a manner well known in the art. However, it is to be noted that interesting and varying visual effects may be obtained by allowing the formation of wrinkles and bubbles in the wrap as applied to the substrate. For example, such irregularities add visual depth and variation to the product, and in the case of glow-in-the-dark labels, a three-dimensional effect is possible. In the case of a PET film having the above-noted thickness and shrinkage characteristics, formed into bands 14 having the above-noted dimensions, and having a glow-in-the-dark design printed thereupon, the bands 14 are subjected to four consecutive stations of hot, dry air (about one to about two seconds each at a temperature of about 100 to about 400° F., preferably about 300 to about 400° F., depending on application), and then to a station of steam (about three to about five seconds at a pressure of about 5 to about 15 psi.)

The number, order, exposure time and intensity of the heating stations can be varied in a known manner according to the specific dimensions and characteristics of the wrap film and the candle or holder.

Once heat-shrinking is complete, the wrapped candle 25 or holder 20 may be dried if necessary by a conventional air blow-dryer or other known mechanism, at which point the candle 25 is ready for packaging, as is the holder 20 once the candle 25 is positioned therein [step SA(4)].

Although the above-described process is preferred, alternative processes may be used. For example, alternative methods utilizing a preformed loop of film are described in the above-noted Spiegel, et al. patent (in which the loop fits loosely over the object before heat-shrinking). The disclosure of this patent is incorporated herein by reference. An alternative method utilizing a sheet that is wrapped around the object is described in U.S. Pat. No. 5,879,496 (Bright, et al.), the disclosure of which also is incorporated herein by reference in its entirety.

As an example of the present invention, a candle jar such as shown in FIG. 1A is encircled by a shrink Polyester Glycol film bearing a cobalt blue background, with phosphorescent stars printed randomly thereupon. A repeat pattern of about 170 mm width is employed, with the stars being screen printed upon the dark blue background. The film is shrink wrapped around the candle jar, to produce a luminary having a dark blue surface coloration, with stars randomly distributed thereupon. After the wrap has been applied, and shrunk to a tight fit around the candle jar, in conventional manner, a candle wick is placed in the approximate center of the jar, and fragranced liquified candle wax is poured to fill the jar approximately to the midpoint. After the wax is solidified, the candle wick is lit, and the candle is allowed to burn on a table surface in a relatively dimly lit room. While burning, the design of the wrap shows a random distribution of bright stars against a dark background. When the candle is extinguished, and the ambient lighting is reduced, the candle jar shows a pattern of bright points of illumination in the darkness, corresponding to the stars of the pattern. This glow-in-the-dark effect continues for a number of minutes before fading.

We have found that the present invention provides an additional advantage in that the shrink wrap, when applied, protects the candle holders, which are typically glass. Specifically, the shrink wrap maintains the integrity of and otherwise protects the glass during production or use from, for example, abrasion or scratching. Such scratches significantly reduce the integrity of the glass. Glass, once scratched, loses compression strength and becomes more fragile. The shrink wrap reduces the incidents of such abrasion or scratching, and preserves the integrity of the glass.

While the present invention has been described with respect to what is at present considered to be the preferred embodiments, it should be understood that the invention is not limited to the disclosed embodiments. To the contrary, the invention is intended to cover various modifications and equivalent arrangements, some of which are discussed above, included within the spirit and scope of the appended claims. Therefore, the scope of the following claims is intended to be accorded the broadest reasonable interpretation so as to encompass all such modifications and equivalent structures and functions.

### INDUSTRIAL APPLICABILITY

The inventive candle decorating method and product utilize heat-shrinkable films to provide a design that cooperates with the light emitted by the candle to achieve a pleasing visual effect, greatly enhancing the aesthetics of the decorative items, by providing a glow-in-the-dark effect which causes the candle or the holder to emit light in a darkened environment. The method and product permit greater flexibility than known methods and products to allow a change, easily and cost-effectively, in production from among varied decorative designs.

We claim:

1. A luminary product having a decorative outer covering, said outer covering comprising a decorative web of a heat-shrinkable polymer web which has been shrunk to conform to the external shape of said product, said web comprising a material which absorbs radiant energy from ambient light and emits light in the absence thereof.

2. A luminary product of claim 1, wherein said luminary product comprises a candle, and said decorative web is adhered to said candle.

3. A luminary product of claim 1, wherein said product comprises a candle and a candle holder, and said decorative web is adhered to said candle holder.

4. A luminary product of claim 3, wherein said candle holder is selected from the group consisting of jars, votive holders, globes, and chimneys.

5. A luminary product of claim 4, wherein said candle holder comprises a glass container for said candle, and said web comprises a heat shrinkable polymer having a design printed thereupon comprising a phosphorescent ink.

6. A luminary product of claim 5, wherein said design comprises plural phosphorescent inks which are activated by the light of said candle.

7. A luminary product of claim 6, wherein said design further comprises nonphosphorescent inks.

8. A luminary product of claim 6, wherein said web comprises a transparent polymeric web.

9. A luminary product of claim 5, wherein said phosphorescent ink is activated by ambient light and emits light when said candle is extinguished.

10. A luminary product comprising a decorative outer covering, said decorative outer covering comprising a polymeric film comprising a material which absorbs radiant energy from ambient light and emits light in the absence thereof, said luminary further comprising an active material.

11. A luminary product as set forth in claim 10, wherein said active material is selected from the group consisting of fragrances, air fresheners, deodorizers, odor eliminators, malodor counteractants, insecticides, insect repellants, medicinal substances, disinfectants, sanitizers, mood enhancers, aroma therapy compositions, and mixtures thereof.

12. A luminary product as set forth in claim 11, wherein said active material is selected from the group consisting of fragrances, insect repellants, insecticides, deodorizers, mood enhancers, and aroma therapy compositions.

13. A luminary product as set forth in claim 12, wherein said product comprises a candle.

14. A luminary product as set forth in claim 12, wherein said product comprises a candle and a candle holder selected from the group consisting of jars, votive holders, globes, and chimneys, said decorative film is adhered to said candle holder, and said film comprises a heat shrinkable polymer having a design printed thereupon comprising at least one phosphorescent ink capable of being activated by the light of said candle.

15. A method for decorating a luminary product, comprising the steps of:
a) providing a heat-shrinkable polymer web comprising a material which absorbs radiant energy from ambient light and emits light in the absence thereof,
b) encasing with the web a substrate selected from the group consisting of candles, candle jars, candle chimneys, candle holders, lanterns, globes, and votive holders; and
c) after the encasing step, heating the web to cause the web to shrink to conform to the shape of said substrate.

16. A method as set forth in claim 15, wherein said film comprises a transparent polymeric web polymer having a design printed thereupon comprising at least one phosphorescent ink capable of being activated by the light of said candle.

17. A method as set forth in claim 16, wherein said film is applied to a glass candle jar encompassing a candle comprising an active material selected from the group consisting of fragrances, insect repellants, insecticides, and deodorizers.

18. A method as set forth in claim 15, wherein the polymer is oriented poly(ethylene terephthalate), wherein the web is preformed into a sleeve with the orientation of the polymer being circumferential to the sleeve, said method further comprising the step of severing the sleeve substantially in the direction of the orientation of the polymer to form a band, and wherein the encasing step comprises positioning the band around candle jar.

19. The method according to claim 18, wherein the web is approximately 50 microns thick.
